(19) United States
(12) Patent Application Publication
(10) Pub. No.: US 2006/0206459 A1
(43) Pub. Date: Sep. 14, 2006

(54) Creation of boolean queries by direct manipulation

(75) Inventor: Matthew B. MacLaurin, Woodinville, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/079,349

(22) Filed: Mar. 14, 2005

(51) Int. Cl. G06F 7/00

(52) U.S. Cl. 707/3

(57) ABSTRACT

A data organization system that utilizes graphical interaction to effect Boolean queries. The subject invention provides for interactive graphical mechanisms that shield users from the semantics of the Boolean logic (e.g., “AND”, “OR”, “NOT”). These mechanisms facilitate the generation of Boolean queries via graphical selection and/or manipulation using iconic query objects. These objects can be interactively selected and/or manipulated by a user via any pointing device in order to create “AND”, “OR” and “NOT” Boolean expressions.

### CROSS-REFERENCE TO RELATED APPLICATION(S)

This application claims the benefit of U.S. Provisional Patent Application Ser. No. ______, filed on Feb. 28, 2005, and entitled “CREATION OF BOOLEAN QUERIES BY DIRECT MANIPULATION,” the entirety of which is incorporated herein by reference.

### TECHNICAL FIELD

This invention is related to computer systems and more particularly to a system and method to construct a query by employing logic operators through direct manipulation.

### BACKGROUND OF THE INVENTION

An English mathematician George Boole developed Boolean logic in the mid-19^{th} century. Essentially, Boolean logic relates to a logical combinatorial system of treating variables, such as propositions and computer logic elements, through the operators AND, OR, and NOT. By analogy, as arithmetic has primary operations such as add, subtract, multiply and divide, the primary Boolean logic operators are AND, OR and NOT.

Boolean algebraic queries have proven to be very useful as applied to computer databases and file systems. However, as Boolean queries become larger, the logic can sometimes require complex analysis of a technical mind. For at least this reason, non-technical users sometimes have difficulty with the complexity exhibited by these Boolean algebraic concepts. For example, non-technical users often cannot distinguish the operation of the Boolean logic operator “AND” from the “OR” operator. As well, parenthetical expressions tend to add to non-technical user confusion.

In operation, Boolean queries utilize one or more conjunction operators (e.g., AND, OR, NOT) to combine predicates thereby determining query results. A predicate is a combination of a property (e.g., name, age) a comparator (e.g., <, >, =) and one or two test values. By way of example, a predicate can take the form of “name=Matt”, “age<30” and “100>size>20.” Boolean operators can be used to combine predicates. For example, “name=Matt OR name=Ivan”, “name=Matt AND age>40” and “name=Matt NOT occupation=manager.” Additionally, parenthesis can be employed to recursively combine Boolean operators without limit. For instance, “name=Matt AND (age>50 OR age<20).”

All in all, Boolean operations in queries are extremely powerful, yet notoriously difficult for non-technical users to master. Extensive studies have found deep confusion between “OR” and “AND” in queries. As well, users tend to ignore or misunderstand the use of parenthesis for structuring compound Boolean queries. What is needed is a system and/or methodology that creates a user-friendly environment to employ Boolean operators. For example, a substantial need exists for a system and/or methodology that provides an interactive graphical means for allowing non-technical users to construct Boolean queries of arbitrary complexity using AND, OR, and NOT conjunctions.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Boolean queries utilize one or more conjunction operators to combine predicates thereby determining query results. A predicate is a combination of a property (e.g., name, age), a comparator (e.g., >, <, =) and one or two test values. Although Boolean queries are an extremely powerful tool to query and/or sort data, they are notoriously difficult for non-technical users to master. Non-technical users often confuse the Boolean operator “OR” with the “AND” operator. As well, non-technical users are often confused by the semantics involved with the use of parenthetical expressions when structuring compound Boolean queries.

The subject invention disclosed and claimed herein, in one aspect thereof, is directed to a novel system that facilitates generating Boolean queries and thereby applying the queries to data. More particularly, the subject invention provides for interactive graphical mechanisms that can shield users from the semantics of the Boolean logic. These mechanisms facilitate the generation of Boolean queries via graphical selection and/or manipulation.

In another aspect, the invention provides for automatic construction of iconic query objects. These objects can be interactively selected and/or manipulated by a user to create “AND”, “OR” and “NOT” Boolean clauses. Again, it is to be appreciated that, because iconic query objects are employed, the subject invention screens the user from the semantics of the Boolean logic. Accordingly, the invention can facilitate non-technical users in creating simple or complex Boolean queries.

In yet another aspect, a graphical user interface (GUI) is provided to present the overall content of a selected data store to a user. Additionally, the GUI can present a list of all available metadata properties to the user. For example, the metadata properties can include, name, size, type, application, modification date, change date, etc. By selecting available metadata properties and sub-properties, a user can create Boolean logic without applying specific Boolean syntactical expressions (e.g., “AND”, “OR”, “NOT”). Moreover, additional operators such as “combine”, “remove”, etc. can be applied thereby manipulating the result of the query in accordance with Boolean or other desired logic.

It will be appreciated that the GUI can be segregated into specific staging areas whereby iconic data representations can be moved thus effecting data manipulation properties. For example, the GUI can include a “workspace” area whereby an icon that represents grouped data can be dragged and dropped. In one aspect, additional icons can be dragged and dropped into the “workspace” area thus combining the groups to create an “AND” operation. Similarly, it is to be appreciated that interactive selections and/or manipulations can be effected to create “OR” and “NOT” Boolean query operators.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a general component block diagram of a system that facilitates interactively generating a query in accordance with an aspect of the subject invention.

FIG. 2 illustrates an exemplary flow chart of procedures to create a query in accordance with a disclosed aspect.

FIG. 3 illustrates a general block diagram that employs a display component in accordance with an aspect of the subject invention.

FIG. 4 illustrates a general block diagram that employs a selection component and a grouping component to manipulate data with respect to properties in accordance with an aspect of the subject invention.

FIG. 5 illustrates a grouping component including rule-based mechanisms in accordance with an aspect of the invention.

FIG. 6 illustrates a grouping component including artificial intelligence-based mechanisms in accordance with an aspect of the invention.

FIG. 7 illustrates a component diagram of an exemplary computing environment in accordance with an aspect of the subject invention.

FIG. 8 illustrates an exemplary user interface (UI) in accordance with an aspect of the invention.

FIG. 9 is an exemplary UI that illustrates a representation of all content in a file system.

FIG. 10 is an exemplary UI that illustrates individual data items that correspond with exemplary grouping parameters in accordance with an aspect.

FIG. 11 is an exemplary aspect that illustrates grouped items that correspond with a selected grouping parameter.

FIG. 12 illustrates an exemplary UI that facilitates selecting a grouped item stack in accordance with a disclosed aspect.

FIG. 13 illustrates an exemplary UI that illustrates individual items that correspond to the selected grouped item.

FIG. 14 illustrates an exemplary UI that facilitates selecting an additional grouping parameter that “drills down” into the content of file system.

FIG. 15 is an exemplary aspect that illustrates grouped items that correspond with a second grouping parameter.

FIG. 16 illustrates an exemplary UI that facilitates selecting a grouped item stack in accordance with a disclosed aspect.

FIG. 17 illustrates an exemplary UI that renders a graphical representation of selected content in accordance with a disclosed aspect.

FIG. 18 illustrates a block diagram of a computer operable to execute the disclosed architecture.

FIG. 19 illustrates a schematic block diagram of an exemplary computing environment in accordance with the subject invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention can be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

As discussed supra, Boolean operations in queries are extremely powerful, yet notoriously difficult for non-technical users to master. For example, extensive studies have found deep confusion between “OR” and “AND in queries. As well, users tend to ignore or misunderstand the use of parentheses for structuring compound Boolean queries. In one aspect, the subject invention provides for an interactive graphical means for allowing non-technical users to construct Boolean queries of arbitrary complexity using “AND”, “OR”, and “NOT” conjunctions. More particularly, aspects of the invention are directed to a system and/or methodology that provides for automatic construction of iconic query objects. Interactive refinement of these query objects, e.g., creation of “AND” clauses, “OR” clauses, and “NOT” clauses are functionality of disclosed aspects.

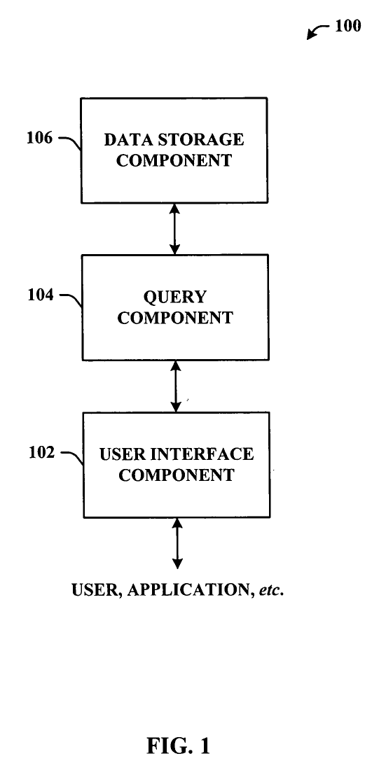

Referring now to FIG. 1, there is illustrated a schematic representation of an aspect of a system 100 that facilitates interactive generation of a query in accordance with the subject invention. Generally, the system 100 can include a user interface (UI) component 102 and a query component 104. System 100 can further include a data storage component 106 which can represent one or more local and/or remote file systems.

The UI component 102 can facilitate interactive generation of the query component 104. For example, the UI component 102 can be a graphical user interface (GUI) whereby a user can manipulate iconic representations of data items via a mouse or other suitable pointing device. More particularly, the user can employ the GUI to select, sort and or group data items based upon any desired criteria. These manipulations can effectively generate a Boolean query while shielding the user from the semantics of the Boolean operator(s). It will be appreciated that the manipulation can based upon any criteria (e.g., metadata property) of the data items. These aspects of the invention can be better understood with reference to the example that follows.

In operation, the UI component 102 can present a view of all data items contained within the data storage component 106. As well, the user can separately be presented with a list of all available criteria (e.g., metadata properties) that correspond to the data items within the data storage component 106. By way of example, properties can include, but are not limited to include, name, size, type, application, modification data, change date, etc. It is to be appreciated that the subject invention can employ any desired schema.

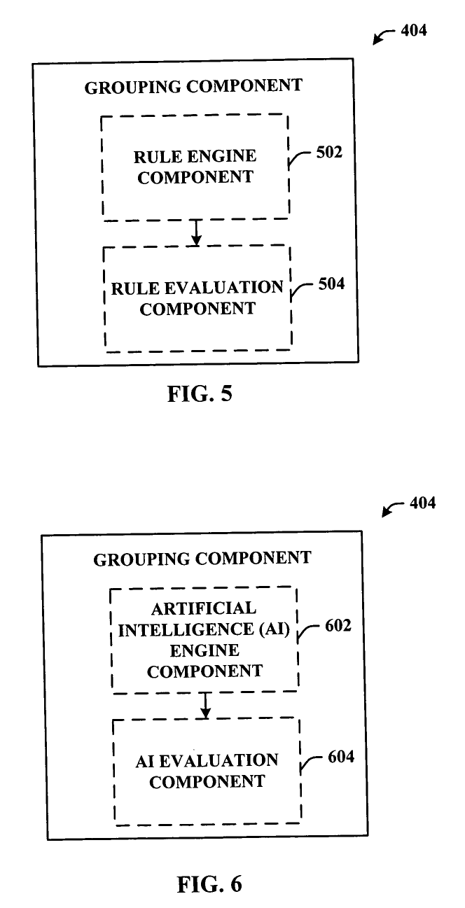

To facilitated establishment of the query component 104, in one aspect, a user can employ a pointing device thus clicking on any of the applicable metadata properties. By clicking on a particular metadata property related to the presented data items, the system can automatically group or regroup the content of the current view based upon similarity of the value of the given property with respect to each item. For instance, if a user clicks on “date”, all of the items with similar dates will automatically be grouped together. In accordance with the invention, any known grouping algorithm can be used for a given property. As well, it is to be appreciated that each property can have a custom algorithm associated therewith. For example, an exemplary grouping algorithm for “creation date” can place recent items in groups corresponding to single days (e.g., “created on Thursday”) while a grouping of older items can be grouped according to month or year (e.g., “created in 2004”). As will be described with reference to FIGS. 5 and 6 infra, grouping algorithms could employ rule-based, adaptive or “artificially intelligent” algorithms as well.

With respect to the GUI (e.g., UI component 108), each group can be represented by a single icon that contains an implicit predicate. A query component 104 can be instantiated for each group icon using the predicate, which defines the group. As will be better understood upon a discussion of the GUI, a “workspace” area can be reserved in the UI component 102. Initially, this “workspace” area is an empty area of the UI component 102.

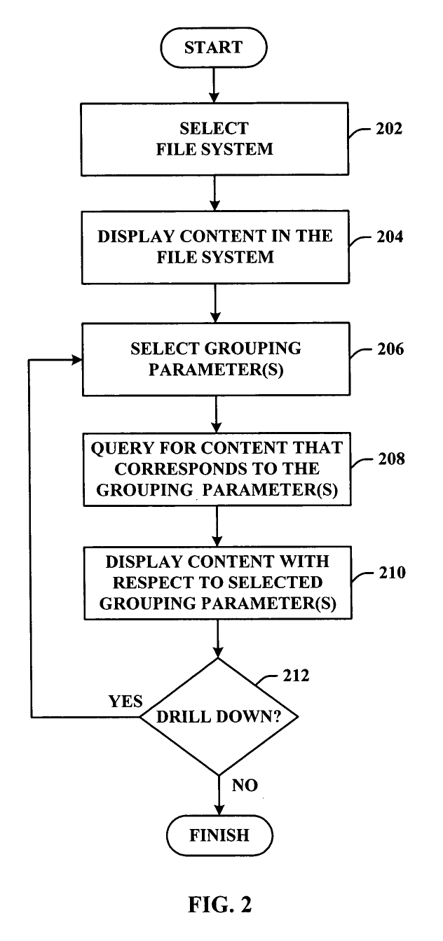

With reference to FIG. 2, there is illustrated a flowchart in accordance to an aspect of the subject invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the subject invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

Referring again to FIG. 2, at 202, a file system (e.g., data storage component, directory, folder) is selected. A representation of the content of the selected file system is rendered at 204. As described supra, a UI component (e.g., GUI) can be employed to display the representation. Additionally, the representation can include available descriptive criteria (e.g., metadata properties) that correspond to the selected content.

At 206, grouping parameters (e.g., metadata property values) can be selected thus initiating a modified rendering of the content. A query is executed upon the selected content at 208 in accordance with the selected grouping parameter(s). At 210, a rendering of the queried content can be effected and grouped in accordance with an appropriate algorithm. Once rendered, a determination is made if additional sorting (e.g., querying, grouping) is desired. If at 212, a determination is made that a “drill down” is not desired, the methodology finishes. If, on the other hand at 212, a determination is made that a “drill down” is desired, the system returns to 206 whereby an additional grouping parameter can be selected thus effecting further refinement of the displayed content.

Essentially, it will be appreciated that a Boolean-type query can be created via the described property selection mechanisms. Further, it will be appreciated that the complexity of this Boolean-type query can be enhanced by recursively drilling down into the selected content as illustrated. Additional exemplary aspects and scenarios are included infra to provide context to the invention. These exemplary aspects and scenarios are not intended to limit the scope and/or functionality as described herein.

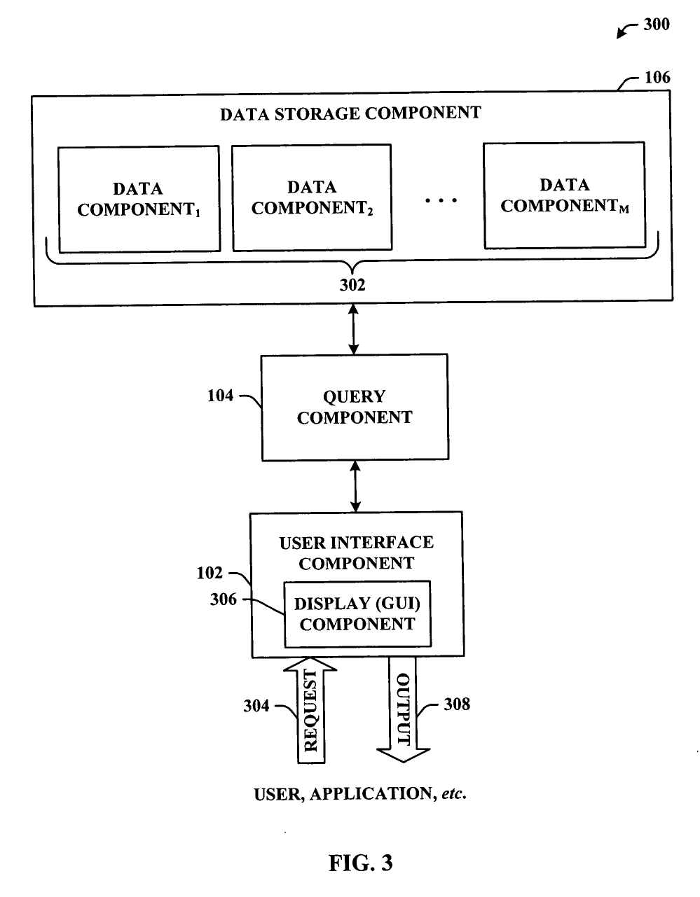

Referring now to FIG. 3, a schematic representation of an alternative system 300 is shown. Generally, system 300 can include a UI component 102, a query component 104 and a data storage component 106. Data storage component 106 can have 1 to M data components therein, where M is an integer. It is to be understood that data components 1 to M can be referred to individually or collectively as data components 302.

As illustrated, UI component 102 can receive a data manipulation (e.g., grouping) request 304. In one aspect, the request 304 can be generated via a user whereby the user employs a pointing device to select iconic representations of content with respect to desired manipulations (e.g., grouping, sorting). The UI component 102 can further include a display (GUI) component 306 that renders the representations to the user. Once requested, the query component 104 can be employed to retrieve content (e.g., data components 302) that correspond with the request 304.

The UI component 102 can employ the display component 306 to render an output 308 that corresponds to the content retrieved in response to the query component 104. As described with reference to the methodology of FIG. 2, it is to be understood that the system 300 can be employed to further “drill down” into the content as desired.

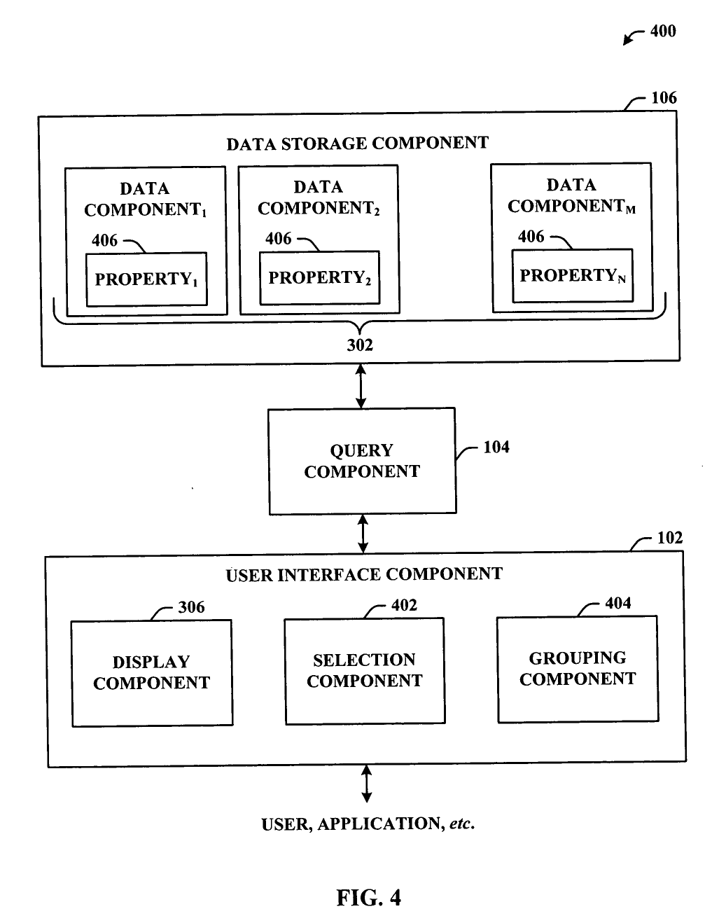

Referring now to FIG. 4, an alternative system 400 is shown. The system 400 generally includes a UI component 102, a query component 104 and a data storage component 106 having 1 to M data components 302 therein, where M is an integer. As illustrated, data components 302 can include 1 to N property identifiers, where N is an integer. It will be appreciated that 1 to N property identifiers can be individually or collectively referred to as property identifier 406. By way of example, property identifiers 406 can represent any identifying metadata property that corresponds to content including, but not limited to, name, size, type, application, modification data, change date, etc.

The UI component 102 can include a selection component 402 that allows a user to select a property identifier 406 for which to group the content. In operation, the display component 306 can identify appropriate property components 406 that correspond to the displayed content. It is to be appreciated that, as a user “drills down” into the content, the displayed property components 406 will change to display available sorting (e.g., grouping) properties with respect to the currently displayed content. Accordingly, the query component 104 can be employed to retrieve content that corresponds to the selected property identifier 406. A grouping component 404 can be employed to group the received content in accordance with the selected property identifier 406.

Referring now to selected exemplary scenarios that effect the generation of Boolean queries while shielding a user from the complex semantics of the operators, the first scenario is directed to creating an “AND” clause. In operation, a user can employ the selection component 402 via a pointing device to double-click (or use an alternate affordance) to open a group/query. The system responds by employing the query component 104 and the grouping component 404 to render the results of the query to the user. It will be appreciated that the results can be rendered via display component 306.

The user can recursively group the contents of the query using either a disparate property, or a more specific grouping of the same property, which defines the group. By way of example, suppose the user initially groups the content by “creation date” and then navigates into the group for “January.” The user may then group recursively by “Author” and navigate into the “Author=Matt” group. It is to be understood and appreciated that this process may be continued recursively, essentially creating a chain of “AND” clauses.

A second exemplary scenario is directed to creating “OR” clauses. The user may select any one or more groups in the UI component 102 and apply a “combine” operator. For example, a user can group a set of items by creation date, select the “January” and “March” sub-groups, and execute the “combine” operator. In this example, this manipulation would create a query with the structure “date=January OR date=March.” It will be appreciated that the exact affordance for the “combine” operator is not limited to this specific expression. Other expressions may include, without limit, dragging the two queries to a specially designated area of the user interface, such as a “shortcuts” pane, and executing the “combine” implicitly. As well, in another aspect, the user can simply drag one of the queries onto the other thus combining them implicitly. Additionally, holding down the “control” key to “control-select” more than one property value could effect a “combine” operation. Once the combine operation completes, the user can navigate into the compound query (e.g., by double-clicking).

Turning now to an example of creating a “NOT” clause, as with the previous example, the user can navigate into a query and group the query contents using any property identifier 406. The user can then select one or more of the resultant groups and apply a “remove” command thus creating a “NOT” clause.

The final exemplary scenario is directed to creating a compound Boolean query. Initially, the user views all items via the display component 306 of the UI component 102. Accordingly, the user employs the selection component 402 to select the “author” property identifier 406. The grouping component 404 effects grouping the content by “author” whereby the representation depicts each “author” as a separate group.

The user can again employ the selection component 402 to navigate into a particular group. In this exemplary scenario, suppose the user navigates into a group corresponding to “author=Matt.” Next, the selection and grouping components 402, 404 can be employed to group the content by “date.” From this resulting group, suppose the user selects the group labeled “Nov. 12, 2004” and places it onto the “workspace” area. At this stage, the query corresponds to “author=Matt” AND date=Nov. 12, 2004”.

Next, the user can return to the all items view via display component 306. Subsequently, a grouping by “author” can be effected. From this view, the group corresponding to “author=Lili” is selected and placed onto the workspace. The user then selects the two queries on the workspace and applies the “combine” operator. It will be appreciated that the “combine” operator can be selected in any manner. For example, the “combine” operator can be presented to a user upon a “right click” operation from the pointing device. As well, pre-defined “control” or “function” keys can be employed to select a “combine” operator.

Accordingly, the query now corresponds to ((author=Matt AND date=Nov. 12, 2004) OR author=Lili). It will be appreciated that this complex Boolean query is generated via user manipulation (e.g., via pointing device selection). Moreover, the user is completely shielded from the semantics of the query components.

To further define the query, the user can group the content by “type” (e.g., picture, music). Next, the user can select the “type=music” group and invoke the “remove” operator. It is to be appreciated that the “remove” operator can be employed in the same manner as described with respect to the “combine” operator supra. The resultant query now corresponds to ((author=Matt AND date=Nov. 12, 2004) OR author=Lili AND NOT type=music). Again, it will be appreciated that the novel functionality of the invention shields the user from the semantics of the Boolean operators and generates the query as a result of manipulation and/or grouping selection commands.

As stated previously, the grouping component 404 can optionally include rule-based and adaptive or “artificial intelligence” based components with respect to algorithmic grouping mechanisms. These alternative aspects are discussed in more detail with reference to FIGS. 5 and 6 that follow.

With reference now to FIG. 5, an alternate aspect of grouping component 404 (and/or selection component 402) (FIG. 4) is shown. More particularly, grouping component 404 generally includes a rule engine component 502 and a rule evaluation component 504. In accordance with this alternate aspect, an implementation scheme (e.g., rule) can be applied to effect grouping of content. It will be appreciated that the rule-based implementation can automatically define and implement a grouping algorithm thus effecting the grouping of selected content. In response thereto, the rule-based implementation can identify a grouping algorithm to be applied by employing a predefined and/or programmed rule(s) based upon any desired criteria (e.g., property value, name, type, file size, date).

By way of example, a user can establish a rule that can automatically group content in accordance with a preferred type of file (e.g., music). In this exemplary aspect, the rule can be constructed to select all music files from a targeted data store or source location thus filtering out non-music content. The resultant set of data components can further be grouped by “genre” in accordance with a predefined rule.

The rule evaluation component 504 facilitates application of the rule. Based upon the output of the rule evaluation component 504, the grouping component 404 can organize the results in accordance with a predefined algorithm thus automating the selection and grouping functionality.

A schematic diagram of another alternative aspect of the grouping component 404 is illustrated in FIG. 6. In addition to or in place of the rule-based components described with reference to FIG. 5, the grouping component 404 (and/or selection component 402) can include an artificial intelligence (AI) engine component 602 and an AI evaluation component 604 that further enhance functionality of the algorithmic mechanisms of the grouping component 404.

In accordance with this aspect, the optional AI engine and evaluation components 602, 604 can facilitate automatically implementing aspects of the grouping component 404. The AI components 602, 604 can optionally include an inference component (not shown) that can further enhance automated aspects of the AI components utilizing, in part, inference based schemes to facilitate inferring intended actions to be performed at a given time and state. The AI-based aspects of the invention can be effected via any suitable machine-learning based technique and/or statistical-based techniques and/or probabilistic-based techniques.

In the alternate aspect, as further illustrated by FIG. 6, the subject grouping component 404 (e.g., in connection with selecting parameters and/or criteria) can optionally employ various artificial intelligence based schemes for automatically carrying out various aspects thereof. Specifically, AI engine and evaluation components 602, 604 can optionally be provided to implement aspects of the subject invention based upon AI processes (e.g., confidence, inference). For example, a process for grouping data items based upon criteria (e.g., property identifiers) values can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of grouping data items included within content, for example, attributes can be file types or other data-specific attributes (e.g., properties) derived from the file types and/or contents, and the classes can be categories or areas of interest.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, and probabilistic classification models providing different patterns of independence can be employed. Classification as used herein also is inclusive of statistical regression that is utilized to develop models of priority.

As will be readily appreciated from the subject specification, the invention can employ classifiers that are explicitly trained (e.g., via a generic training data) as well as implicitly trained (e.g., via observing user behavior, receiving extrinsic information). For example, SVM's can be configured via a learning or training phase within a classifier constructor and feature selection module. In other words, the use of expert systems, fuzzy logic, support vector machines, greedy search algorithms, rule-based systems, Bayesian models (e.g., Bayesian networks), neural networks, other non-linear training techniques, data fusion, utility-based analytical systems, systems employing Bayesian models, etc. are contemplated and are intended to fall within the scope of the hereto appended claims.

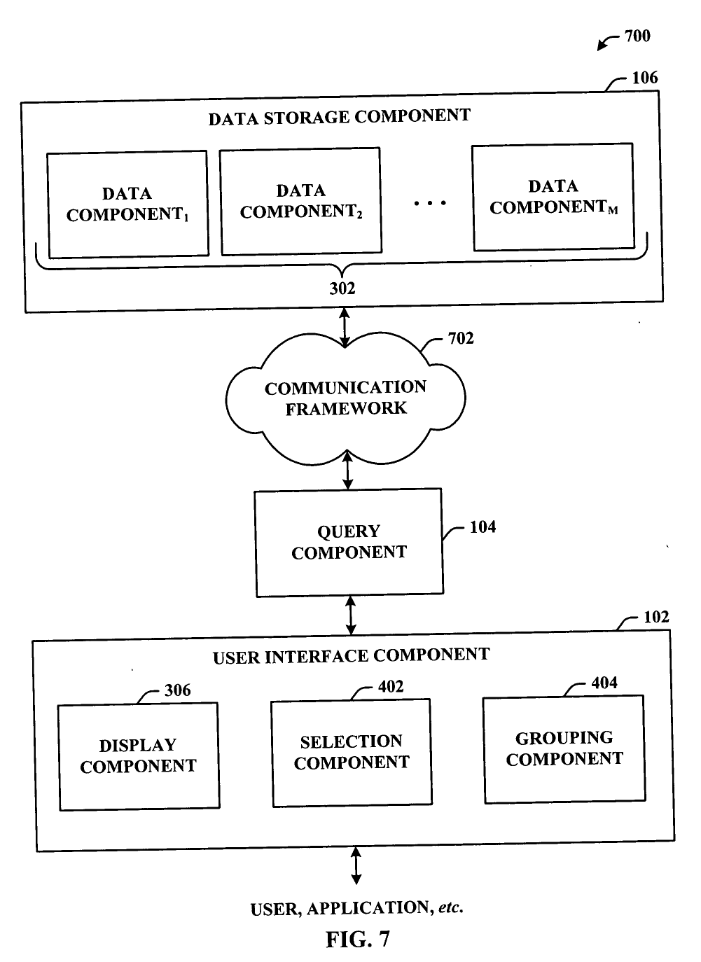

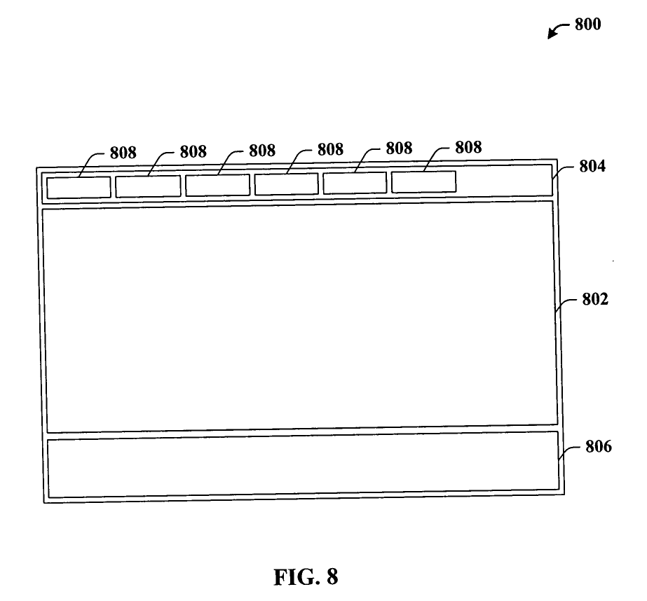

Referring to FIG. 7, a schematic block diagram of an exemplary computing environment is shown in accordance with an aspect of the subject invention. Specifically, the system 700 illustrated includes a UI component 102 that includes a display component 306, a selection component 402 and a grouping component 404. Further, the system can include a query component 104 and a data storage component 106 having data components 302 therein. It is to be understood that these components can have the same functionality as discussed in detail supra. Additionally, the system 700 illustrated employs a communication framework 702 whereby the UI component 102 and/or the query component 104 can be located remotely from the data storage component 106. Communications framework 702 can employ any communications technique (wired and/or wireless) known in the art. For example, communications framework 702 can include, but is not limited to, Bluetooth™, Infrared (IR), Wi-Fi, Ethernet, or the like.

FIGS. 8 through 17 illustrate an exemplary UI in accordance with an aspect of the invention. It is to be appreciated however, that the subject invention is not limited to the examples shown and described herein. Other alternative aspects exist without departing from the scope and/or functionality of the invention.

Referring initially to FIG. 8, an exemplary UI 800 is illustrated. Generally, FIG. 8 illustrates the primary interface areas of UI 800 that include a content display region 802, a grouping control area 804 and an aggregate construction surface 806. As shown, grouping control area 804 can include 1 to P group parameter selectors, where P is an integer. It is to be understood that group parameter selectors 1 to P can be referred to individually or collectively as group parameter selectors 808. As discussed supra, group parameter selectors 808 can represent any metadata property (e.g., type, date, author) that corresponds to the content.

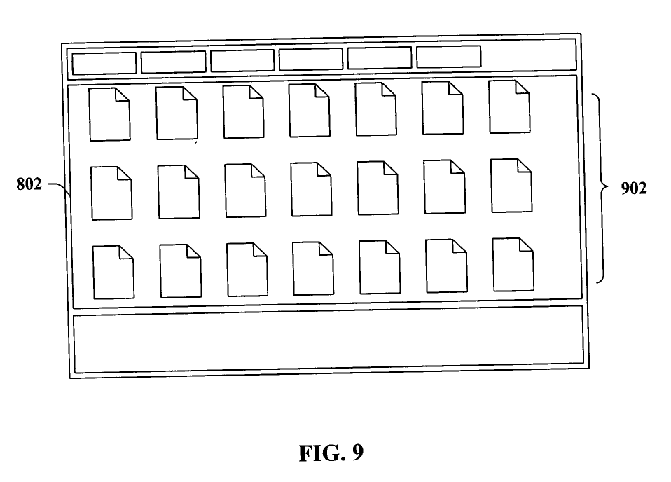

Turning now to FIG. 9, a representation of the content can be rendered in the content display region 802. For example, as illustrated, the content display region 802 can include an iconic representation (e.g., thumbnail) of the files corresponding to the file system. It is to be appreciated that any representation can be employed without departing from the scope and/or functionality of the invention. For example, in another exemplary aspect, a “details” or list view can be employed whereby the file name of the individual data items (e.g., 902) can be displayed.

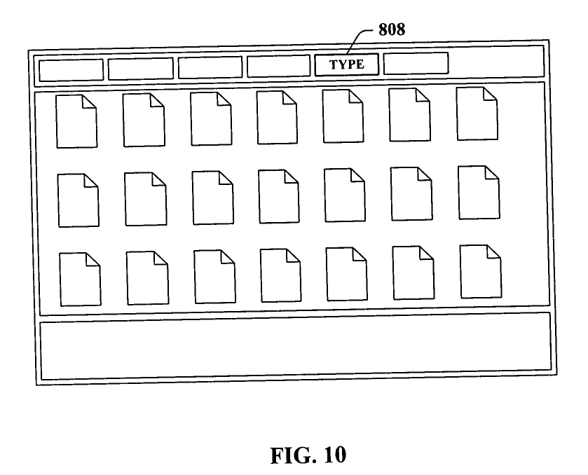

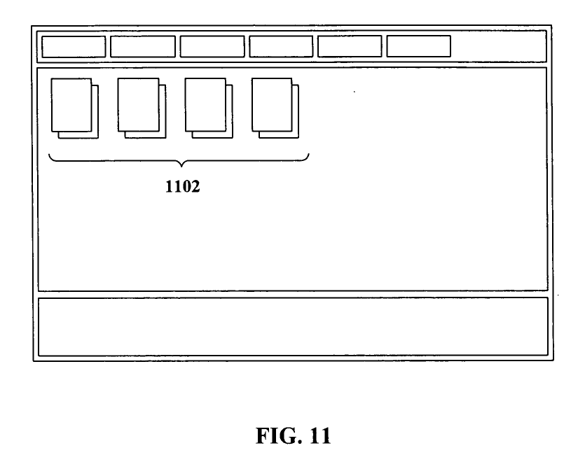

Once the content (e.g., representation 902) is displayed, a user can select a desired group parameter selector 808 whereby the content will be grouped accordingly. By way of example, and with reference to FIG. 10, the user can select “type” (e.g., image file), “date” or “author” that corresponds to a desired group parameter selector 808. Next, as illustrated in FIG. 11, individual files are replaced with “group icons” 1102 that correspond to the selected grouping parameter. For example, if the user selects the grouping parameter selector 808 that corresponds to “type”, the group icons 1102 can correspond to individual data “types” such as “pictures,” “documents,” “music,” etc.

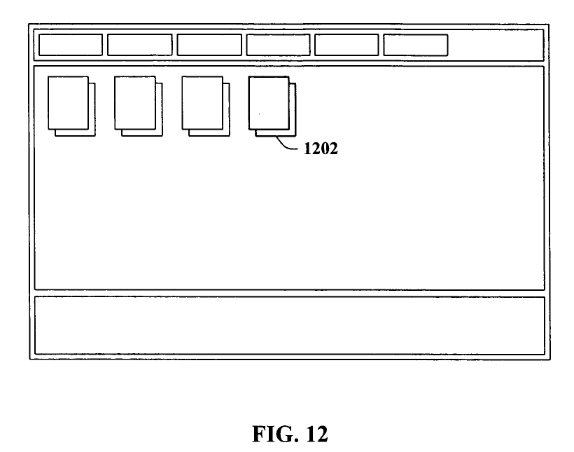

As shown in FIG. 12, the user can then select one of the group icons (e.g., 1202) by double-clicking via a pointing device. It is to be understood that any mechanism of selection can be employed without departing from the spirit and/or scope of the invention. By way of further example, a user can employ navigational keyboard keys (e.g., arrows) to navigate to and select a desired group. Continuing with the example, suppose the user selects the “pictures” group.

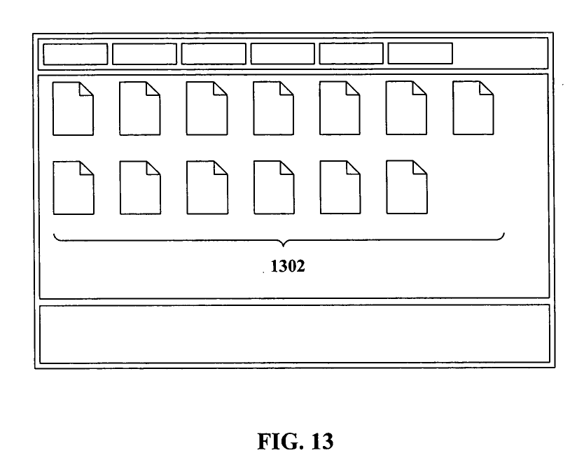

FIG. 13 illustrates an exemplary UI in accordance with such a selection. Upon selecting the “pictures” group, the system can display individual items 1302 that correspond to the group with respect to the content of the file system. It will be appreciated that all of these items 1302 satisfy a single predicate that is implied by the particular group selected. In other words, at this point, items 1302 represent all items where “Type=Picture.”

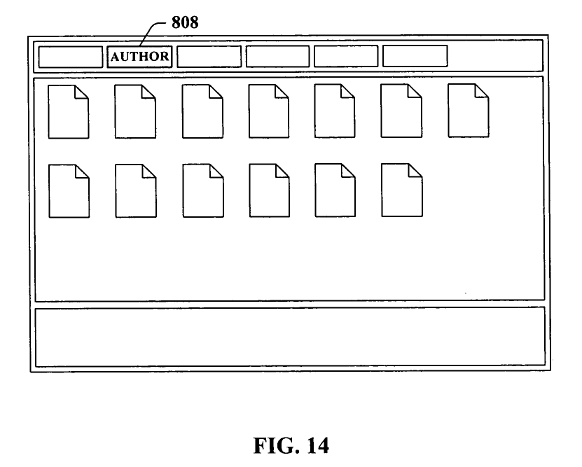

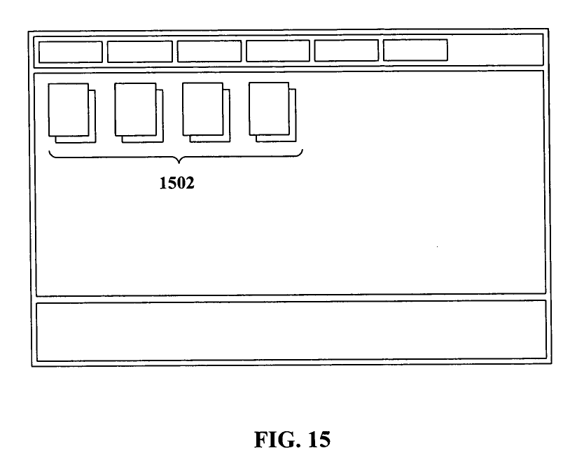

Next, the user can select another desired group parameter selector 808 as illustrated in FIG. 14. In this example, suppose the user selects the “author” group parameter selector 808. As shown in FIG. 15, the individual files are replaced with “group icons” 1502 that correspond to the new grouping parameter (e.g., “author”). Continuing with the example, the user has now chosen to group by “author” therefore, there is now one group icon displayed for each author that corresponds to the content.

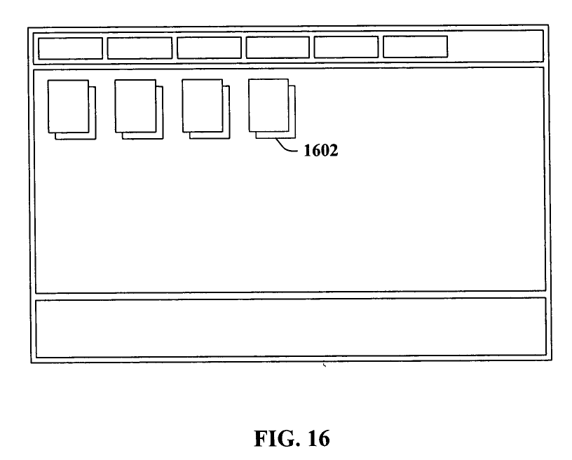

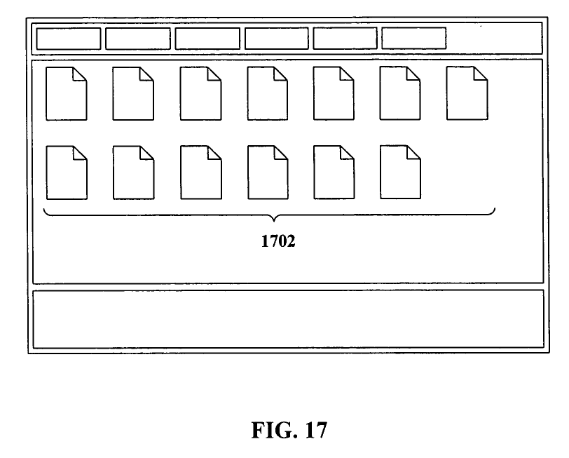

Referring now to FIG. 16, the user can select (e.g., double-click) one of the group icons that correspond to a desired author. For example, a user can select the group 1602 that corresponds to “Matt.” Next, as shown in FIG. 17, the system can display the individual items 1702 that correspond to the “Matt” group. It will be appreciated that these items 1702 satisfy a single predicate implied by the particular group opened. As well, it is to be understood that these items were selected from a previously selected group. In other words, items 1702 correspond to all items where “Type=Picture AND Author=Matt.” As described supra, it is to be appreciated that the user can continue to “drill down” into the content as desired—creating additional query conditions thereby increasing the complexity of the query.

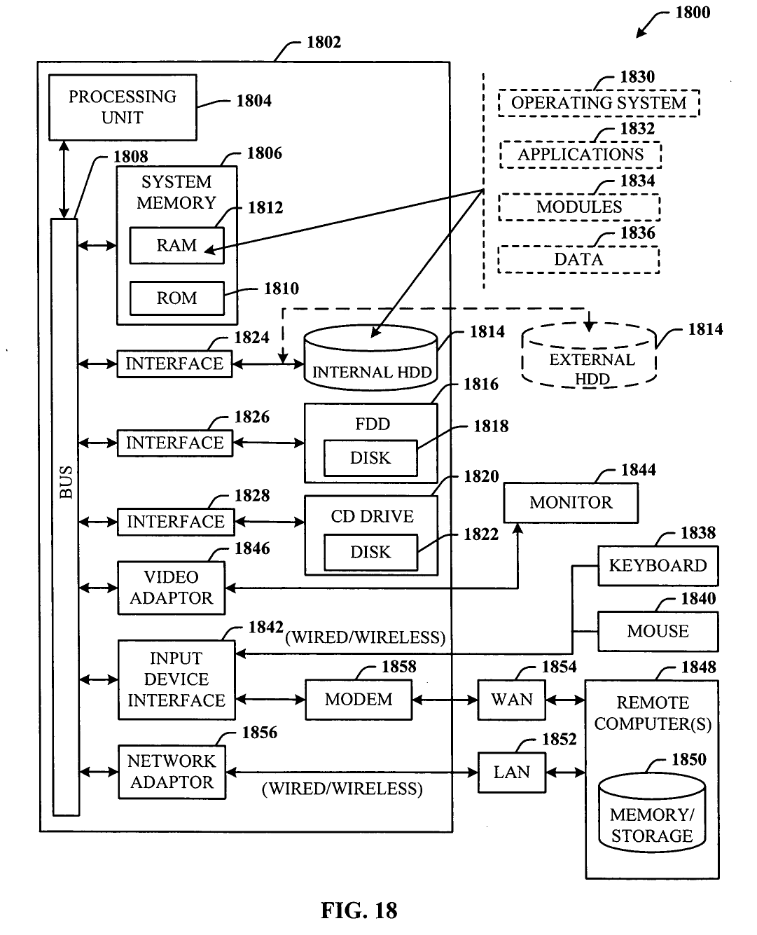

Referring now to FIG. 18, there is illustrated a block diagram of a computer operable to execute the disclosed architecture. In order to provide additional context for various aspects of the subject invention, FIG. 18 and the following discussion are intended to provide a brief, general description of a suitable computing environment 1800 in which the various aspects of the subject invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 18, there is illustrated an exemplary environment 1800 for implementing various aspects of the invention that includes a computer 1802, the computer 1802 including a processing unit 1804, a system memory 1806 and a system bus 1808. The system bus 1808 couples system components including, but not limited to, the system memory 1806 to the processing unit 1804. The processing unit 1804 can be any of various commercially available processors. Dual microprocessors and other multi-processor architectures may also be employed as the processing unit 1804.

The system bus 1808 can be any of several types of bus structure that may further interconnect to a memory bus (with or without a memory controller), a peripheral bus, and a local bus using any of a variety of commercially available bus architectures. The system memory 1806 includes read only memory (ROM) 1810 and random access memory (RAM) 1812. A basic input/output system (BIOS) is stored in a non-volatile memory 1810 such as ROM, EPROM, EEPROM, which BIOS contains the basic routines that help to transfer information between elements within the computer 1802, such as during start-up. The RAM 1812 can also include a high-speed RAM such as static RAM for caching data.

The computer 1802 further includes an internal hard disk drive (HDD) 1814 (e.g., EIDE, SATA), which internal hard disk drive 1814 may also be configured for external use in a suitable chassis (not shown), a magnetic floppy disk drive (FDD) 1816, (e.g., to read from or write to a removable diskette 1818) and an optical disk drive 1820, (e.g., reading a CD-ROM disk 1822 or, to read from or write to other high capacity optical media such as the DVD). The hard disk drive 1814, magnetic disk drive 1816 and optical disk drive 1820 can be connected to the system bus 1808 by a hard disk drive interface 1824, a magnetic disk drive interface 1826 and an optical drive interface 1828, respectively. The interface 1824 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the subject invention.

A number of program modules can be stored in the drives and RAM 1812, including an operating system 1830, one or more application programs 1832, other program modules 1834 and program data 1836. All or portions of the operating system, applications, modules, and/or data can also be cached in the RAM 1812. It is appreciated that the subject invention can be implemented with various commercially available operating systems or combinations of operating systems.

A user can enter commands and information into the computer 1802 through one or more wired/wireless input devices, e.g., a keyboard 1838 and a pointing device, such as a mouse 1840. Other input devices (not shown) may include a microphone, an IR remote control, a joystick, a game pad, a stylus pen, touch screen, or the like. These and other input devices are often connected to the processing unit 1804 through an input device interface 1842 that is coupled to the system bus 1808, but can be connected by other interfaces, such as a parallel port, an IEEE 1394 serial port, a game port, a USB port, an IR interface, etc.

A monitor 1844 or other type of display device is also connected to the system bus 1808 via an interface, such as a video adapter 1846. In addition to the monitor 1844, a computer typically includes other peripheral output devices (not shown), such as speakers, printers, etc.

The computer 1802 may operate in a networked environment using logical connections via wired and/or wireless communications to one or more remote computers, such as a remote computer(s) 1848. The remote computer(s) 1848 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory storage device 1850 is illustrated. The logical connections depicted include wired/wireless connectivity to a local area network (LAN) 1852 and/or larger networks, e.g., a wide area network (WAN) 1854. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1802 is connected to the local network 1852 through a wired and/or wireless communication network interface or adapter 1856. The adaptor 1856 may facilitate wired or wireless communication to the LAN 1852, which may also include a wireless access point disposed thereon for communicating with the wireless adaptor 1856. When used in a WAN networking environment, the computer 1802 can include a modem 1858, or is connected to a communications server on the WAN 1854, or has other means for establishing communications over the WAN 1854, such as by way of the Internet. The modem 1858, which can be internal or external and a wired or wireless device, is connected to the system bus 1808 via the serial port interface 1842. In a networked environment, program modules depicted relative to the computer 1802, or portions thereof, can be stored in the remote memory/storage device 1850. It will be appreciated that the network connections shown are exemplary and other means of establishing a communications link between the computers can be used.

The computer 1802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with conventional network or simply an ad hoc communication between at least two devices.

Wi-Fi, or Wireless Fidelity, allows connection to the Internet from a couch at home, a bed in a hotel room or a conference room at work, without wires. Wi-Fi is a wireless technology like a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

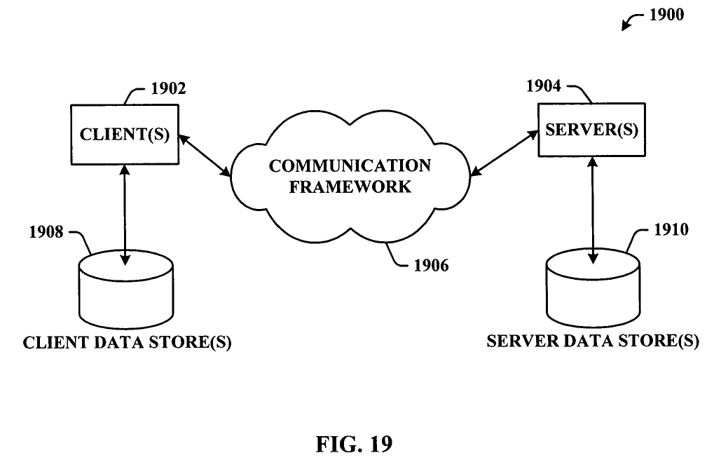

Referring now to FIG. 19, there is illustrated a schematic block diagram of an exemplary computing environment 1900 in accordance with the subject invention. The system 1900 includes one or more client(s) 1902. The client(s) 1902 can be hardware and/or software (e.g., threads, processes, computing devices). The client(s) 1902 can house cookie(s) and/or associated contextual information by employing the subject invention, for example. The system 1900 also includes one or more server(s) 1904. The server(s) 1904 can also be hardware and/or software (e.g., threads, processes, computing devices). The servers 1904 can house threads to perform transformations by employing the subject invention, for example. One possible communication between a client 1902 and a server 1904 can be in the form of a data packet adapted to be transmitted between two or more computer processes. The data packet may include a cookie and/or associated contextual information, for example. The system 1900 includes a communication framework 1906 (e.g., a global communication network such as the Internet) that can be employed to facilitate communications between the client(s) 1902 and the server(s) 1904.

Communications can be facilitated via a wired (including optical fiber) and/or wireless technology. The client(s) 1902 are operatively connected to one or more client data store(s) 1908 that can be employed to store information local to the client(s) 1902 (e.g., cookie(s) and/or associated contextual information). Similarly, the server(s) 1904 are operatively connected to one or more server data store(s) 1910 that can be employed to store information local to the servers 1904.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates querying data, the system comprising:
a component that displays a plurality of graphical indicia representative of content in a data store;
an interface component that converts a data selection request into a query operator, the data selection request employs the plurality of graphical indicia; and
a query component that processes the query operator to retrieve data from a data storage component.

2. The system of claim 1, further comprising a component that displays a representation of the retrieved data.

3. The system of claim 1, the query operator is a Boolean logic operator.

4. The system of claim 3, the Boolean logic operator is one of “AND”, “OR” and “NOT.”

5. The system of claim 1, the data selection request is a grouping request, the grouping request relates to a metadata property of the content.

6. A user interface component that employs the system of claim 1 wherein the query operator is a Boolean “AND” operator.

7. A user interface component that employs the system of claim 1 wherein the query operator is a Boolean “OR” operator.

8. A user interface component that employs the system of claim 1 wherein the query operator is a Boolean “NOT” operator.

9. The system of claim 1, the interface component comprises:
a rule engine component that automatically instantiates a rule that implements a predefined criteria; and
a rule evaluation component that applies the rule with respect to grouping the retrieved data.

10. The system of claim 1, further comprising an artificial intelligence component that predicts a user intention as a function of historical user criteria.

11. The system of claim 10, the artificial intelligence component comprises an inference component that facilitates grouping the received data as a function of the predicted user intention.

12. A computer readable medium having stored thereon the components of claim 1.

13. A method for organizing data, the method comprising:
displaying a plurality of graphical indicia representative of content in a data store;
identifying a plurality of properties associated with the content;
selecting one of the plurality of properties; and
grouping the content into a plurality of collections based upon the selected property.

14. The method of claim 13, further comprising displaying the plurality of collections.

15. The method of claim 13, further comprising recursively grouping the content based upon one of a disparate property and a sub-property of the selected property.

16. The method of claim 13, further comprising:
selecting a plurality of collections;
combining the selected plurality of collections; and
displaying the plurality of collections.

17. The method of claim 13, further comprising:
selecting an additional one of the plurality of properties; and
removing content that corresponds to the additional one of the plurality of properties.

18. A system for filtering data, the system comprising:
means for displaying content of a data store;
means for rendering a plurality of properties associated with the content;
means for selecting at least one of the plurality of properties;
means for grouping the content into a plurality of collections based upon the selected property; and
means for rendering the plurality of collections.

19. The system of claim 18, further comprising means for recursively grouping the content based upon one of a disparate property and a sub-property of the selected property.

20. The system of claim 18, further comprising:
means for selecting a plurality of collections;
means for executing one of a combine and a remove operation with regard to the selected plurality of collections; and
means for displaying the plurality of collections.
